(19) United States
(12) Patent Application Publication
(10) Pub. No.: US 2004/0205407 A1
(43) Pub. Date: Oct. 14, 2004

(54) Sequence controller and control method

(76) Inventors: Kenji Sakakibara, Handa-city (JP); Toshihiro Takenaka, Nishio-city (JP); Michiyasu Kurihara, Handa-city (JP)

Correspondence Address: HARNESS, DICKEY & PIERCE, P.L.C., P.O. BOX 828, BLOOMFIELD HILLS, MI, 48303, US

(21) Appl. No.: 10/789,912

(22) Filed: Feb. 27, 2004

(30) Foreign Application Priority Data
Feb. 28, 2003 (JP) 2003-053888

(51) Int. Cl. H02H 3/05

(52) U.S. Cl. 714/31

(57) ABSTRACT

A programmable logic controller having a data holding unit for storing operation data for instructing operations and condition data for the operations in accordance with a predetermined sequence, having a variable control unit for generating operation instruction signals from the operation data in accordance with a predetermined sequence, and controlling a system for successive operation when conditions defined by the condition data and conditions input from sensors of the control system match.

### BACKGROUND OF THE INVENTION

1. Field of the Invention

The present invention relates to a controller, more particularly a sequence controller such as a programmable logic controller (PLC).

2. Description of the Related Art

In the past, the control circuit for operating a PLC for controlling a production system etc. or circuit diagram for expressing a program was individually prepared in accordance with the operation routines or operation sequence of the system. Standardization and reuse were difficult.

The design of a control circuit using a conventional ladder circuit diagram (hereinafter referred to as a “ladder diagram”) and its problems will be explained next with reference to FIGS. 6 to 9.

The example of a conveyance process of a workpiece will be used as an example. That is, a loader advances from an initial position by a cylinder etc. When reaching the advancement end, the loader descends. When the loader reaches the bottom end, a chuck grasps the workpiece. The loader then rises and retracts to return to the initial position and releases the workpiece.

FIG. 6 is a flow chart of the operation sequence from when the process starts to when the loader reaches the descent end.

At step S1, the loader starts to advance by a start signal. At step S2, whether the loader has reached the advancement end is judged by detection by a detector such as a limit switch or optoelectric switch. When the detector is OFF and the loader has not reached the advancement end, the loader continues to advance. However, when the detector is ON and the loader has reached the advancement end, at step S3, the loader starts to descend. At step S4, the loader continues to descend until it is detected that the loader has reached the descent end.

When the sequence of operations of the loader is as explained above, the ladder diagram becomes as shown in FIG. 7. L1 to L3 of the ladder diagram correspond to steps S1 to S3.

That is, when the start switch is turned on by the start signal, a coil C1 is excited and the loader starts to advance (L1). When the loader reaches the advancement end, this is detected by the detector, the switch s1 is turned on, and the coil A is excited (L2). As a result, the B contact a1 of the coil A opens and the advance of the loader stops, while the A contact a3 closes, the coil C2 is excited, and the loader starts to descend (L3). Note that the A contact a2 is a self-holding contact of the coil A. Next, when the loader descends to the descent end, the contact s2 becomes on by the detector, the coil B is excited, a signal confirming the descend end of the loader is issued, the B contact b1 becomes off, and the descent of the loader is stopped. The next step is then proceeded to. Note that the A contact b2 is for self holding the coil B.

When using such a ladder diagram, if an operation routine is corrected as shown in FIG. 8, it is necessary to correct or change the ladder diagram as shown in FIG. 9.

FIG. 8 shows the flow shown in FIG. 6 plus step S5 for blowing air to blow away dirt etc. adhering to the chuck etc. when the loader reaches the advancement end and descends for gripping the workpiece. In this case, the ladder diagram has the line L5 inserted as shown in FIG. 9. The air is blown by confirming that the loader has reached the advancement end, turning on the contact a3, and issuing an air blow signal. The contact b1 is a switch turned off by the signal confirming that the loader, not shown, has reached the descent end.

By adding this line L5, the signal for causing the descent of the loader is turned on by a coil D excited by the air blow being turned on. The contact notation is changed from a to d. As will be understood from this simple example, an actual ladder diagram is large in scale and complicated, so when there are major design changes or corrections relating to a large number of locations, change and correction of the ladder diagram are extremely complicated and difficult. There has never been any attempt to fundamentally reevaluate ladder diagrams to solve this problem.

Summarizing the problems to be solved by the invention, due to the need to design a ladder diagram based on the operation routines considered for each system, it is necessary to newly prepare a ladder diagram considering the system after a design change such as a change of the operation routines. Therefore, the related control signals have to be newly set etc.—resulting in inefficiency and a large load.

Even with the same operation routines, each designer will use different techniques for converting them to a ladder diagram. Therefore, unless the designer or the person adjusting the design is in charge of the modifications, time is taken for understanding the huge ladder diagram. Reassembly was necessary.

Even in debugging work for ensuring that a system operates as in the operation routines after design, work was required for correcting and reassembling the ladder diagram.

While attempts have been made for standardization, the result has only been partial reuse for system control seen before. Control circuits still have to be designed by first viewing the entirety of the design of the machine units. Ladder diagrams of different systems are almost never reused and could not be standardized.

### SUMMARY OF THE INVENTION

An object of the present invention is to provide a controller or control able to provide a system control circuit or program with a high degree of completeness in a short time without having to design a ladder diagram for each system and able to flexibly deal even with design changes or debugging and achieve a great improvement in productivity of control design work.

To attain the above object, according to a first aspect of the invention, there is provided a sequence controller for system control provided with a data holding unit and a control unit, wherein the data holding unit stores operation data instructing operations and condition data for causing operations in accordance with a predetermined sequence, and the control unit generates operation instruction signals for instructing the operations from the operation data in accordance with a predetermined sequence and executes the operations when conditions defined in the condition data are satisfied.

In this way, the first aspect of the invention was made by taking note of the fact that operation of a controlled object proceeds in series by operation conditions for the start of operations being satisfied. By applying this aspect of the invention to system control, it becomes possible to easily control a system in the same way as an experienced control designer by just setting operation data and condition data based on desired operation steps.

Further, by employing the sequence controller of the first aspect of the present invention, even with changes in operations after installation of the system, there is no need for changing the control ladder diagram. Therefore, it is possible to realize a high productivity. Further, since a program is produced substantially by just designating operations and their conditions, standardization of programs can be achieved.

Preferably, the condition data includes monitoring data or other numerical data. The other numerical data may be time data. Further, the controller may determine whether the conditions are satisfied by comparing input signals from the system being controlled and the condition data.

Preferably, the control unit converts the operation data and condition data to input/output data of each slot. The operation data and condition data are input through a system control setting menu entering the operations and the conditions for each processing step.

By using the system control setting menu, even a machine designer with no control knowledge can control the system by expressing the desired operation steps in the system control setting menu, and changes in operations after installation of a system can be easily made by reconversion of the system control setting menu.

According to a second aspect of the present invention, there is provided a system control method having a plurality of steps, data of each step having operation data instructing operations and condition data for the operations, comprising a step of generating operation instruction signals from the operation data and a step of causing operation of the system by the operation instruction signals when the condition data and data obtained from the system match.

Preferably, the condition data includes preset time data and steps for causing operation of the system cause operation of the system conditional on the time having elapsed.

According to a third aspect of the invention, there is provided a control system provided with a data preparation/input device for preparing operation data for causing operation in accordance with a predetermined sequence and condition data for causing the operation as numerical data, a programmable logic controller having a data holding unit for storing numerical data input from the data preparation/input device and a control unit, and a production system having various types of sensors, the programmable logic controller generating operation instruction signals from the operation data and causing operation of the production system when the condition data matches with data from detection signals from the sensors.

According to a fourth aspect of the invention, there is provided a programming method for producing a program for a programmable logic controller, comprising a step of forming steps of processing comprised of a plurality of steps by operation data and operation condition data for that operation based on operation routines, a step of storing the operation data and the operation condition data as numerical data in accordance with the operation routines, and a step of converting the numerical data to data for each slot of the programmable logic controller.

With the method of programming of the fourth aspect of the invention, there is no need to design a ladder diagram for each system as in the past. Design for an individual system can be realized by just preparing operation data and condition data for the system in accordance with the operation routines.

### BRIEF DESCRIPTION OF THE DRAWINGS

These and other objects and features of the present invention will become clearer from the following description of the preferred embodiments given with reference to the attached drawings, wherein:

FIG. 1 is a schematic view of a control system of a first embodiment of the present invention;

FIG. 2 is a view of an allocation table of the first embodiment of the present invention;

FIG. 3 is a view of a system control setting menu of the first embodiment of the present invention;

FIG. 4 is an explanatory view of the data structure of a data holding unit of a PLC of the first embodiment of the present invention;

FIG. 5 is a flow chart of the flow of control of the first embodiment of the present invention;

FIG. 6 is a view of an example of the operation of the system equipment;

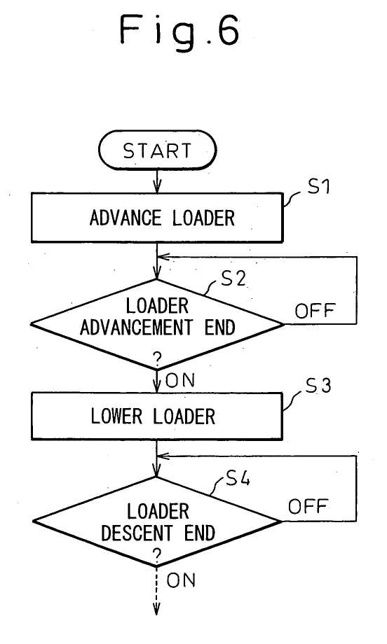

FIG. 7 is a ladder diagram of the operation of the system equipment shown in FIG. 6;

FIG. 8 is a view of an example of an additional operation of the system equipment; and

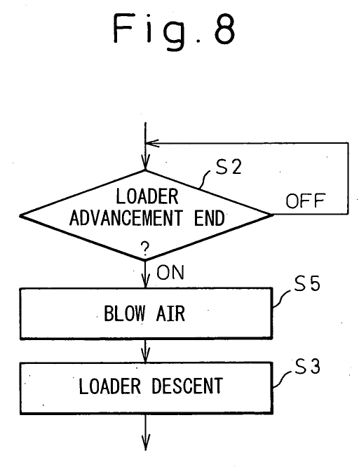

FIG. 9 is a ladder diagram of an additional operation of the system equipment shown in FIG. 8.

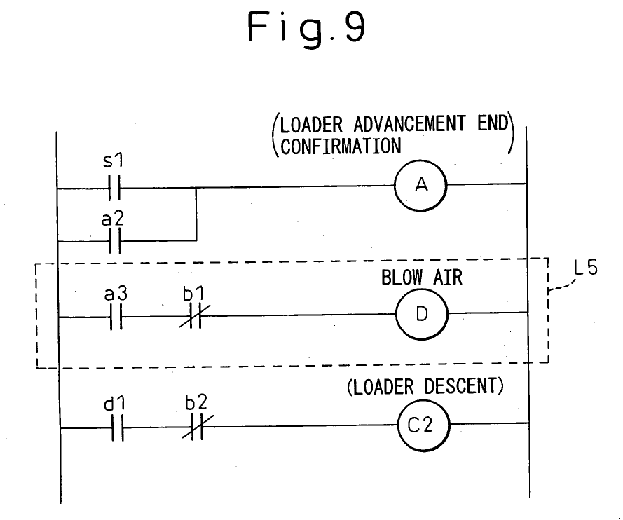

### DESCRIPTION OF THE PREFERRED EMBODIMENTS

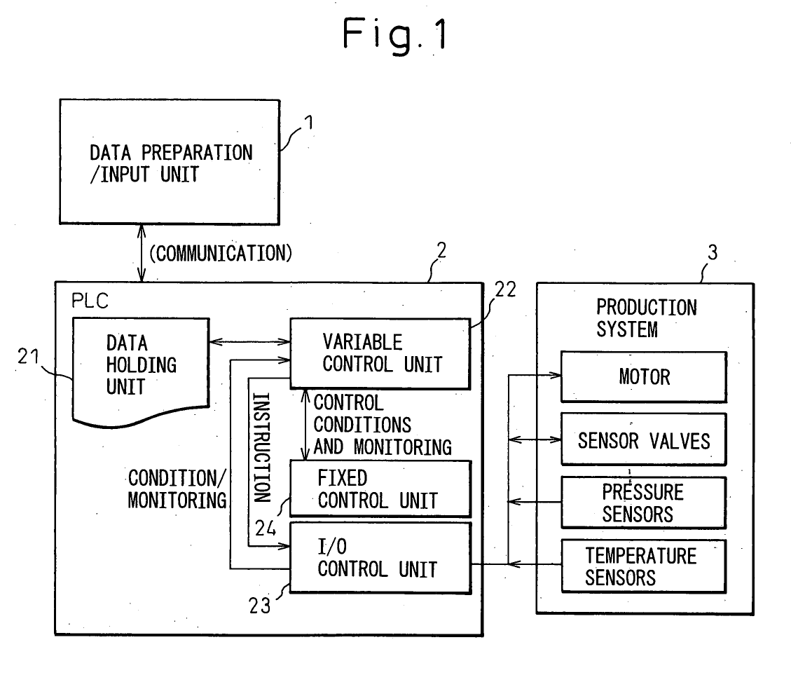

Preferred embodiments of the present invention will be described in detail below while referring to the attached figures. FIG. 1 shows the overall system of a first embodiment of the present invention. The first embodiment of the system of the present invention is comprised of a data preparation/input unit, a programmable logic controller 2, and a production system 3.

The data preparation/input unit is comprised of a PC outside of the PLC and has the function of converting operation routines to numerical values able to be judged by a PLC and the function of writing numerical data into a data area in the PLC.

The PLC has a data holding unit 21, a variable control unit 22, a fixed control unit 23, and an I/O control unit. The data holding unit 21 is a block for holding numerical data obtained by conversion of the operation routines and operation conditions inside the PLC.

The variable control unit 22, the fixed control unit 23, and the I/O control unit 24 are all comprised so as to be controlled by programs or circuits defined by the ladder diagram.

That is, the variable control unit 22 is configured by a ladder diagram controlling system operation based on data. It successively analyzes the operation sequence and operation conditions of the data holding unit 21 and controls the selection and execution of operations by the ladder diagram in the I/O control unit 23. The I/O control unit 23 is configured by a ladder diagram creating units of operations of equipment and controlling the input/output necessary for operations. By creating units of operations of equipment for control, it is possible to achieve suitable control for each field of systems.

Note that the timings of the operation sequence of the I/O control unit are determined by instructions of the variable control unit 22.

The fixed control unit 24 is configured by a ladder diagram controlling requirements common to controlled objects or control modes such as system quality, safety, reliability, etc. so that for example when an emergency stop button is pushed, the system operation stops.

The production system 3 is the object being controlled by the PLC. For example, it is configured so that it is driven by a motor and so that detection signals and numerical data from sensor valves, pressure sensors, and temperature sensors are input to the PLC.

As the means for input from the data preparation/input unit to the PLC, it is possible to use wireless or wired LANs or use RS232C cables. Further, it is possible to use floppy disks, compact disks, or other portable media. Further, the data preparation/input unit was provided outside of the PLC, but it may also be provided inside the PLC.

Next, the method of control of the present invention will be explained taking as an example control of the loader used for the explanation of the related art.

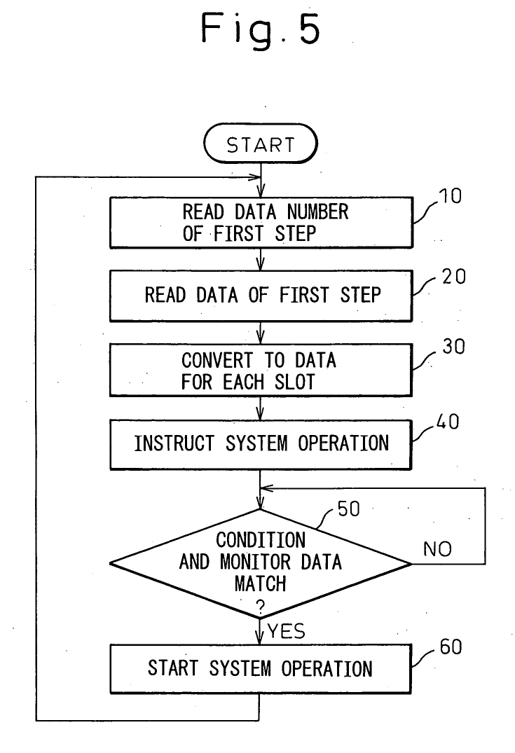

First, a flow chart for system control such as shown in FIG. 5 is prepared. Next, in the same way as in the related art, an allocation table corresponding to slots of the PLC used for the system is prepared. This allocation table can be prepared by commercially available spreadsheet software or general use text editing software.

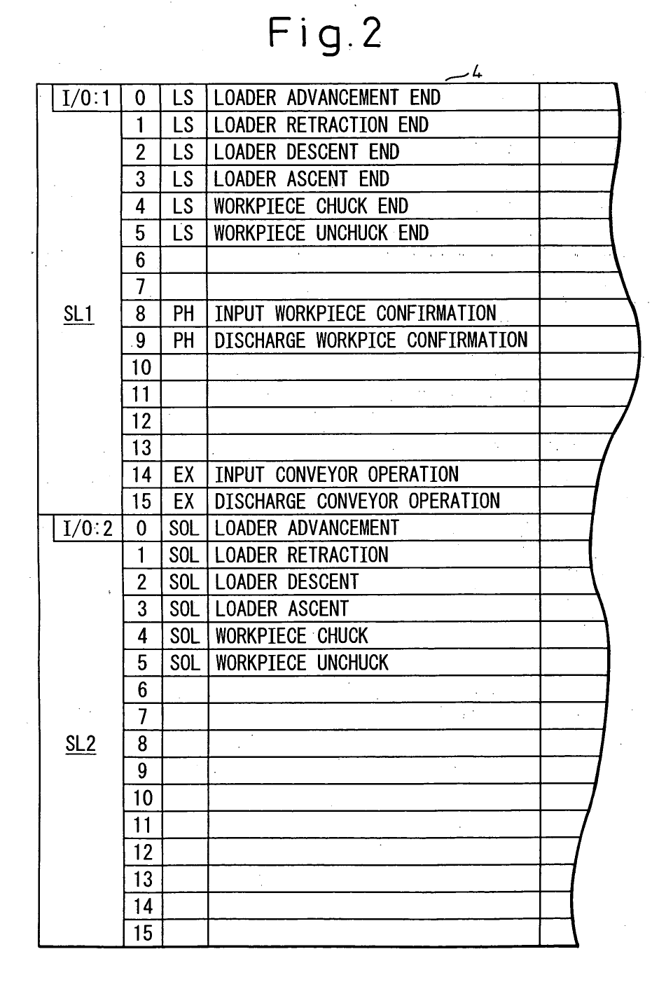

FIG. 2 shows an example of an I/O allocation table. The allocation table 4 is a table showing the correspondence between input signals and output signals and the I/O ports of the PLC and is prepared corresponding to the cards inserted into the PLC slots.

The field SL1 corresponds to the input use card I/O 1 of the slot SL1. Input signals are allocated to the ports used among the 16 ports 0 to 15. Specifically, SL1 is allocated for signals showing the state of a loader, state of a workpiece, and state of a conveyor. For example, the 0 port of the I/O 1 (hereinafter referred to as “100” etc., where the 15 port of the I/O 1 is expressed by “115”) is allocated “loader advancement end” and is allocated a signal showing that the loader is at the advancement end. “108” is allocated “input workpiece confirmation” and is allocated a signal showing that an input workpiece to be chucked is present. “114” is allocated a signal showing that the input conveyor is in operation.

The field SL2 corresponds to an output use card I/O 2 of the slot SL2. Output signals are allocated to the ports used. For example, the 0 port of I/O 2, that is, “200”, is allocated a signal corresponding to loader advancement. Note that the slots in this example are merely illustrations. The invention is naturally not limited to 16 ports.

When the allocation table 4 finishes being prepared, the data preparation/input unit reads software for setting data of the allocation table 4 and registers allocation numbers of the PLC 2. In this example, the allocation table data is operation data instructing operation of the system, condition data showing conditions on which operations of the system are predicated, monitor data, and numerical data showing the operation time etc. The monitor data does not directly instruct the state of operation of the system, but for example shows the state of the related equipment and therefore becomes a condition for operation of the system. The numerical data is time lag data etc. set when it is necessary to start operation after waiting for stabilization even when the operation conditions are satisfied and in the final analysis also gives conditions for operation of the system.

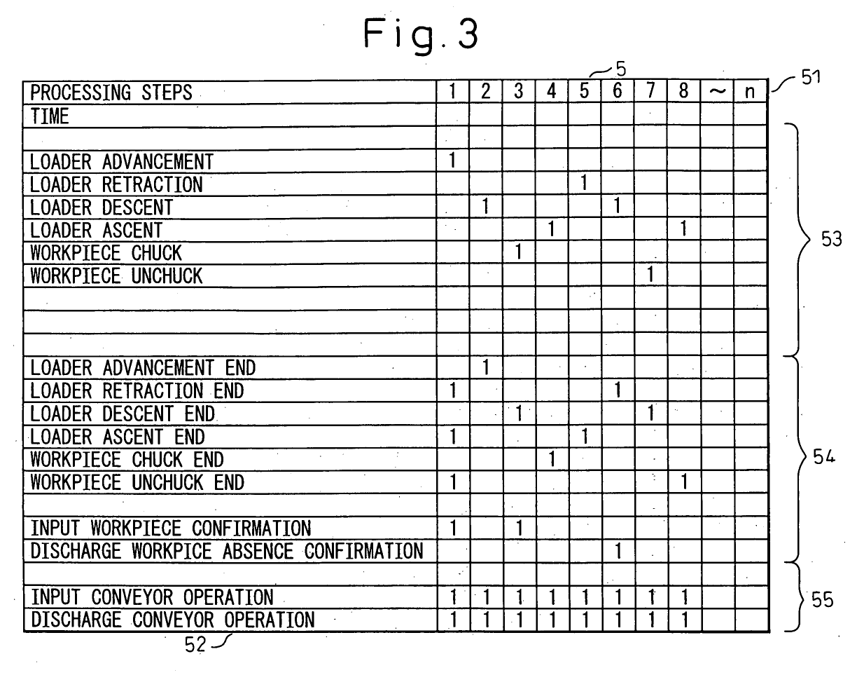

Next, using the system control setting menu shown in FIG. 3, operation data, condition data, monitor data, and other numerical data are input for each step of the control operation.

The system control setting menu 5 has as column headings 51 operation routines provided by the machinery designers allocated as processing step 1 to processing step n, has as row headings 52 fields expressing operations of machinery and equipment, conditions for the operations, and monitoring classified into operation data 53, condition data 54, and monitor data 55, and enables entry of data for operation, conditions, and monitoring for each processing step. In this example, the numerical data is operation time and is entered at “TIME” of the row headings 52.

The operation data 51 for instructing operations of a system corresponds to the operations of a loader in this example and includes loader advancement, loader retraction, etc. The condition data 52 corresponds to conditions for determining the timing of starting, stopping, etc. of the operations of the loader. The monitor data 53 monitors the operation of the conveyor and gives conditions for starting and stopping operations of the loader. The condition data 52 and monitor data 53 are data showing conditions upon which operations of a system are predicated.

The rows below the headings 51 expressing the processing steps enable the entry of time data of the steps as numerical data. In general, the time lag for start of operation is set in many cases. For example, when chucking a part, when desiring to confirm that stable chucking is achieved and start the next operation or when waiting for a certain degree of cooling after the heating operation has ended, these are used for cases of adjusting time conditions other than operation conditions. Note that in this example, the time conditions are omitted. The system control setting menu is not limited to a table of the above format. It need only enable descriptions and conditions etc. for each step corresponding to the sequence of the processing steps.

A control designer uses a data preparation/input unit such as a PC to input operation, condition, and monitor data of each step at the system control setting menu 5 based on operation routines (flow charts) provided by the machine designers.

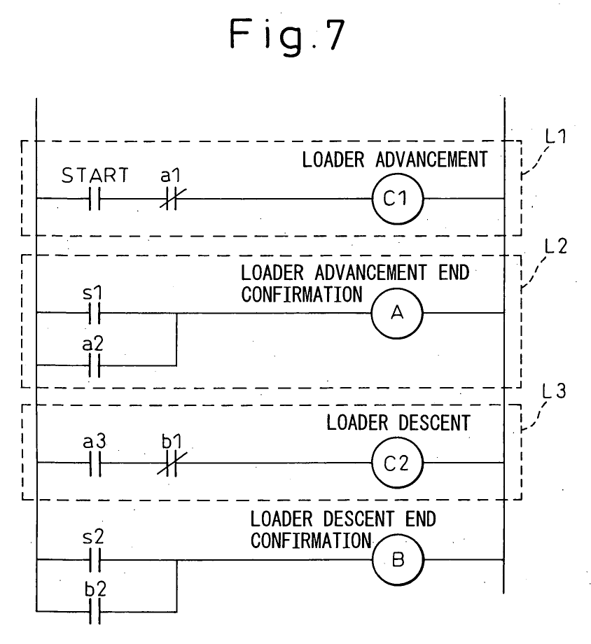

For example, processing step 1 corresponds to step S1 of FIG. 7. “1” is entered in the corresponding field. That is, the operation data is “loader advancement”, while the condition data is “loader retraction end”, “loader ascent end”, and “workpiece unchuck end”. At processing step 1, when the condition data and monitor data are all actually input and confirmed, the operation of loader advancement is executed and the next step 2 is proceeded to.

At processing step 2, the operation data is “loader descent”, while the conditions for the start of operation are condition data of “loader advancement end” and monitor data of “input conveyor operation” and “discharge conveyor operation”. (Hereinafter, in all steps, the monitor data has to be “input conveyor operation” and “discharge conveyor operation”, so mention of the monitor data will be omitted.)

At processing step 3, the operation data is “workpiece chuck”, while the condition data for the start of operation is “loader descent end” and “input workpiece confirmation”.

At processing step 4, the operation data is “loader ascent”, while the condition data for the start of operation is “workpiece chuck end”.

At processing step 5, the operation data is “loader retraction”, while the condition data for the start of operation is “loader ascent end”.

At processing step 6, the operation data is “loader descent”, while the condition data for the start of operation is “loader retraction end”.

At processing step 7, the operation data is “workpiece unchuck”, while the condition data for the start of operation is “loader descent end”.

At processing step 8, the operation data is “loader ascent”, while the condition data for the start of operation is “workpiece unchuck end”.

In the case of this example, when proceeding to processing step 8, the routine returns to processing step 1, where the processing is repeated. Note that it is also possible not to repeat all of the steps, but to set things so that part of the processing steps are repeated. Further, it is possible to omit some of the processing steps.

Even if not knowing about ladder control technology, a person who can suitably set system control if the operation routines (operation flow) is shown can prepare the system control setting menu 5. The persons preparing a system control setting menu 5 of the present invention are therefore not limited to control designers.

When the operation data, condition data, and monitor data are input in the order of the system operations to the system control setting menu 5, the data entered to the system control setting unit 5 is converted to numerical data which the PLC 2 can judge by the data preparation/input unit 1. The obtained numerical data is written and stored in the data holding unit 21 inside the PLC.

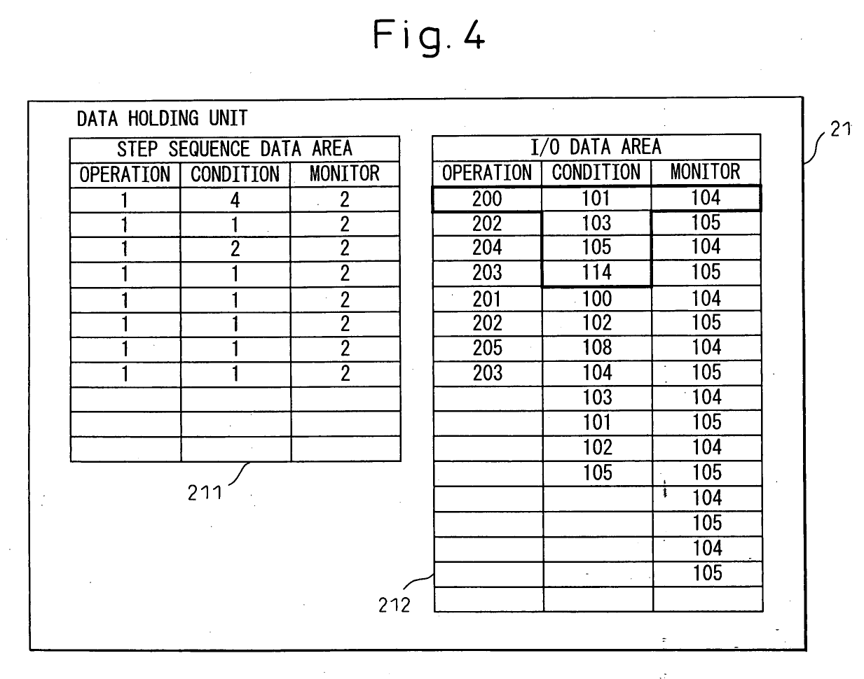

The converted and stored numerical data is comprised of the step sequence data and input/output data. As shown in FIG. 4, it is written into the step sequence data area 211 and the I/O data area 212.

The step sequence data stored in the step sequence data area 211 shows numbers of operation, condition, and monitor data as in the sequence of steps entered in the system control setting menu. In FIG. 4, the data numbers of steps 1 to 8 are given from the top to bottom in the step sequence storage area. For example, at step 1, the operation data number is “1” (“loader advancement”), the condition data number is “4” (“loader retraction end”, “ladder ascent end”, “workpiece unchuck end”, and “input workpiece confirm”). The monitor data number is “12”, (“input conveyor operation” and “discharge conveyor operation”).

The input/output data stored in the I/O data area 212 is the data from step 1 to step 8 divided into the operation, condition, and monitor fields and shows the corresponding allocation numbers of the PLC. Unlike a step sequence storage area, each row does not correspond to a step. Step 1 corresponds to the area enclosed by the bold lines. The operation data is arranged at the port “200”, (loader advancement), the condition data at “101” (loader retraction end), “103” (loader ascend end), “105” (workpiece unchuck end), and “1114” (input workpiece confirmation), and the monitor data at “104”, (input conveyor operation) and “105” (discharge conveyor operation).

Next, for execution of the control operation of the PLC 2, a ladder diagram (program) for operation of the variable control unit 22, I/O control unit 23, and fixed control unit 24 is input. Note that the ladder diagram is input to the variable control unit 22, the I/O control unit 23, and the fixed control unit 24 independently from the input of the operation data and other data, so may be input before the input of the operation data etc. Further, it has general properties, so does not require new input of another ladder diagram in accordance with the operation data. Next, the variable control unit 22 starts control of the system based on the ladder diagram input to the variable control unit 22 based on the step sequence data and input/output data input to the data holding unit. Note that the fixed control unit 23 controls the failsafe etc. and does not directly perform the system control of this example, so its explanation will be omitted.

Next, the control operation of a system by the PLC 2 of the first embodiment of the present invention will be explained with reference to FIG. 5. First, at block 10, the data number of step 1 stored in the step sequence data area 211 of the data holding unit 21 is read into the variable controller.

Next, at block 20, the read area number of the I/O data area is calculated from the data number of step 1 (“1” for operation data, “4” for condition data, and “2” for monitor data). The operation, condition, and monitor data are read for the amount calculated.

At block 30, the read data is assigned to the input/output slots allocated to the PLC and converted to input/output data for each slot.

Next, at clock 40, the input/output data for each slot is transferred to the input/output control unit 23 and instructs operation of the system. That is, at step 1 of this example, an instruction for advancement of the loader is given.

After instructing advancement of the loader, the input data from the production system 3 and the condition/monitor data of step 1 are compared and a match awaited. That is, when the condition that the loader be at the retraction end and ascent end and at the workpiece unchuck end and the presence of the input workpiece be confirmed and the condition that the input conveyor and discharge conveyor be operating are satisfied by the input data from the production system 3, operation of the system is started. Here, when numerical data regarding the operation time of step 1 (for example, the time lag when starting operation) is set, input of numerical data showing the elapse of the set time is also a condition of the start of the operation of the system.

Next, the processing proceeds one step and returns to block 10 where the operation of the next step 2 is prepared for. In this way, predetermined steps proceed serially.

As explained above, according to the embodiments of the present invention, even a machinery designer with no control knowledge can easily control a system in the same way as an experienced control designer by just realizing desired operation steps in a system control setting menu.

Further, changes in operation after installation of a system can be made by reconverting the system control setting menu without having to change the control ladder diagram and therefore can enable realization of a high productivity.

The present invention is suitable for control of for example a production system, for example can be applied to control of washing systems, surface treatment systems, drying systems, and other treatment systems, assembly systems, cutting systems, and all other types of systems. However, the present invention is of course not limited to application to the control of production systems.

While the invention has been described with reference to specific embodiments chosen for purpose of illustration, it should be apparent that numerous modifications could be made thereto by those skilled in the art without departing from the basic concept and scope of the invention.

What is claimed is:

1. A sequence controller for system control provided with a data holding unit and a control unit, wherein:
said data holding unit stores operation data instructing operations and condition data for causing said operations in accordance with a predetermined sequence, and
said control unit generates operation instruction signals for instructing said operations from said operation data in accordance with a predetermined sequence and executes said operations when conditions defined in said condition data are satisfied.

2. A sequence controller as set forth in claim 1, wherein said condition data includes monitoring data.

3. A sequence controller as set forth in claim 1, wherein said condition data includes other numerical data.

4. A sequence controller as set forth in claim 3, wherein said other numerical data is time data.

5. A sequence controller as set forth in claim 1, which determines whether said conditions are satisfied by comparing an input signals from said system being controlled and said condition data.

6. A sequence controller as set forth in claim 1, wherein said control unit converts said operation data and condition data to input/output data of a programmable logic controller.

7. A sequence controller as set forth in claim 1, wherein said operation data and condition data are input through a system control setting menu entering said operations and said conditions for each processing step.

8. A system control method having a plurality of steps, data of each step having operation data instructing operations and condition data for said operations, comprising:
a step of generating operation instruction signals from said operation data and
a step of causing operation of said system by said operation instruction signals when said condition data and data obtained from said system match.

9. A system control method as set forth in claim 8, wherein said condition data includes preset time data and steps for causing operation of said system cause operation of said system conditional on said time having elapsed.

10. A control system provided with:
a data preparation/input device for preparing operation data for causing operation in accordance with a predetermined sequence and condition data for causing said operation as numerical data,
a programmable logic controller having a data holding unit for storing numerical data input from said data preparation/input device and a control unit, and
a production system having various types of sensors,
said programmable logic controller generating operation instruction signals from said operation data and causing operation of said production system when said condition data matches with data from detection signals from said sensors.

11. A programming method for producing a program for a programmable logic controller, comprising:
a step of forming steps of processing comprised of a plurality of steps by operation data and operation condition data for that operation based on operation routines,
a step of storing said operation data and said operation condition data as numerical data in accordance with said operation routines, and
a step of converting said numerical data to data for each slot of said programmable logic controller.
